(19) United States
(12) Patent Application Publication
(10) Pub. No.: US 2012/0016735 A1
(43) Pub. Date: Jan. 19, 2012

(54) System and Method for Providing Personalized Advertisement Service

(76) Inventors: Sung-Kuk Park, Evanston, IL (US); Young Sik Yoon, Evanston, IL (US); Sungphil Kim, Evanston, IL (US); Jaemin Park, Evanston, IL (US)

(21) Appl. No.: 12/838,685

(22) Filed: Jul. 19, 2010

(51) Int. Cl. G06Q 30/00

(52) U.S. Cl. 705/14.42; 705/14.55

(57) ABSTRACT

A system and method for providing a personalized advertisement service are disclosed. In one embodiment, the advertisement providing system includes a contents server for storing a plurality of contents to provide contents in response to a user's request, generating a request of an advertisement transmission to the user and information about the requested contents, when a contents request made by the user is received, and transmitting the contents to the user when the advertisement transmission to the user is completed and an advertisement server for storing a plurality of advertisement files, constructing a first advertisement menu comprising a list of advertisements corresponding to the contents information in response to an advertisement transmission request by the contents server, providing a first advertisement file selected by the user via the first advertisement menu to the user, constructing a second advertisement menu including a list of advertisements corresponding to the first advertisement file selected via the first advertisement menu when the contents transmission to the user by the contents server is completed and providing a second advertisement file selected by the user via the second advertisement menu to the user.

### BACKGROUND OF THE INVENTION

1. Field of the Invention

The present invention relates to a system and method for providing an advertisement service, and more particularly, to a system and method for providing an advertisement service in which a personalized advertisement menu and an advertisement selected by a user are provided in response to a user's contents request so as to increase a user's degree of interest in advertisement.

2. Description of the Related Art

As the Internet becomes popular, the number of advertisements is increasing and various advertisement methods are also being developed. The most general advertisement method is an advertisement method using a banner or widget, or a pop-up window. An advertisement method using a banner simply outputs a banner in a portion of a web page to attract the attention of a user, and if a user selects the banner, more information is delivered to the user. That is, advertisement contents are inserted in a form of a banner or widget in a portion of a web page, and when a person who has access to the corresponding website selects the advertisement contents by clicking on the banner or widget or locating a pointer of a mouse on the banner or widget, a linked website is opened or a particular file, such as a moving picture, is executed.

In addition to such an advertisement method, there is an advertisement method in which when a user requests a server that provides a web service to allow him or her to access to a text document such as a news piece, a moving picture, or a picture, an advertisement is transmitted together with the requested information. For example, according to an agreement between a contents provider and a business person who requests exposure of an advertisement, a plurality of advertisement files are databased and stored in advance, and when a user requests a server that provides moving picture contents to allow him or her to download certain content, one or more advertisements are exposed for a predetermined time period before the download, and then the downloading begins. FIG. 1 is a block diagram illustrating a general system for providing an advertisement service combined with contents.

As illustrated in FIG. 1, a user who wants the download of contents has an access to a contents server via a terminal, and makes a contents transmission request by selecting a list of contents shown on a web page provided by the contents server. The contents server inserts an advertisement to the contents requested by the user and transmits the advertisement-inserted contents to the terminal. The user fully views the inserted advertisement before the download of the contents, and after the advertisement viewing is finished, the contents are downloaded.

Meanwhile, in exchange for exposure of an advertisement, business people who want to advertise pay advertisement fees to the contents provider, and there are various methods of pricing advertisement fees. For example, there are a cost-per-click (CPC) method, a cost-per-action (CPA) method, a cost-per-sale (CPS) method, a cost-per-entry (CPE) method, etc. The CPC method, which is the most frequently used, determines how much is to be paid when a user clicks once on an advertisement in the form of a key word or a banner.

In regard to the advertisement insertion type of advertisement providing system, a plurality of advertisements provided by business people who have an advertisement exposure agreement are data-based and stored, and when a user requests contents, one or more advertisements among a plurality of advertisements are arbitrarily inserted into contents. In this kind of advertisement method, however, a user may not pay attention to the advertisement itself other than the contents, and rather, frequent exposure of the advertisements may force the user to view unwanted advertisements, thereby resulting in user's complaints. In addition, since the inserted advertisement is not related to disposition and interests of the user, the corresponding advertisement may not attract the attention of the user. In addition, in the case that business people pay an advertisement fee based on cost-per-click or cost-per-exposure, even when the advertisement fails to attract the user's attention despite the exposure of the advertisement, the equivalent advertisement fee is incurred, which is disadvantageous to the business people who want to advertise.

In addition, when a user views an advertisement for a certain period of time, the corresponding revenue resulting from the advertisement viewing is given to only a contents provider without any consideration of the economic value created by the advertisement viewing, which may be irrational to the user. That is, unlike a general public media, which exposes an advertisement to unspecified persons, according to the advertisement insertion method, individuals may have different exposure frequencies with respect to the same advertisement. If compared to the economic value created by the advertisement viewing, the advertisement fee paid by business people who want to advertise is too small or the revenue given to the contents provider is too high, and some of the difference needs to be returned to the user. However, the return may not be embodied in the advertisement system described above.

### SUMMARY OF THE INVENTION

The present invention provides a system and method for providing an advertisement service, capable of improving problems caused by a decrease in the user's attention even when an advertisement is exposed to the user, and irrational distribution of revenue without any consideration of the economic value created by the advertisement viewing.

According to an aspect of the present invention, there is provided an advertisement providing system comprising a contents server for storing a plurality of contents to provide contents in response to a user's request, generating a request of an advertisement transmission to the user and information about the requested contents, when a contents request made by the user is received, and transmitting the contents to the user when the advertisement transmission to the user is completed and an advertisement server for storing a plurality of advertisement files, constructing a first advertisement menu comprising a list of advertisements corresponding to the contents information in response to an advertisement transmission request by the contents server, providing a first advertisement file selected by the user via the first advertisement menu to the user, constructing a second advertisement menu including a list of advertisements corresponding to the first advertisement file selected via the first advertisement menu when the contents transmission to the user by the contents server is completed and providing a second advertisement file selected by the user via the second advertisement menu to the user.

According to another aspect of the present invention, there is provided an advertisement server that comprises a plurality of advertisement files, and is synchronized with a contents server and provides an advertisement file to a user, the advertisement server comprising an advertisement menu constructing unit for constructing first and second advertisement menus that are to be transmitted to the user in response to an advertisement transmission request transmitted by the contents server, an advertisement file transmission unit for transmitting first and/or second advertisement file in response to a selection of the user with respect to the first and/or second advertisement file, a state information transmitter and receiver for transmitting information about complete transmission of the first advertisement file to the contents server when transmission of the first advertisement file is completed, and receiving information about complete transmission of contents when transmission of the contents to the user is completed and a database unit for data-basing a plurality of advertisement files, account information about a user who logs in the advertisement server, and user's advertisement files selection details and storing the data-based results, and wherein the advertisement menu constructing unit constructs the first advertisement menu in response to the advertisement transmission request transmitted by the contents server, and constructs the second advertisement menu in response to information about complete transmission of the contents.

According to another aspect of the present invention, there is provided a method of providing an advertisement providing system for storing a plurality of advertisement files, receiving, from a contents server for receiving a contents transmission request from a user, an advertisement transmission request and category information about a category of contents selected by a user, constructing a first advertisement menu comprising a list of at least one advertisement file corresponding to the contents category information, providing a first advertisement file selected by the user via the first advertisement menu to the user, constructing a second advertisement menu comprising a list of at least one advertisement file related to the first advertisement file, when the transmission of the first advertisement file and transmission of contents to the user from the contents server are completed and providing a second advertisement file selected by the user via the second advertisement menu to the user.

### BRIEF DESCRIPTION OF THE DRAWINGS

The above and other features and advantages of the present invention is to become more apparent by describing in detail exemplary embodiments thereof with reference to the attached drawings in which:

FIG. 1 is a block diagram illustrating a general system for providing an advertisement service combined with contents;

FIG. 2 is a diagram illustrating an advertisement providing system according to an embodiment of the present invention;

FIG. 3 is a block diagram illustrating a method of providing the advertisement providing system of FIG. 2;

FIGS. 4A and 4B are views to sequentially explain operations for performing the method for providing the advertisement providing system of FIG. 2;

FIG. 5 is a view to sequentially explain functions related to a method of selecting a donation receiver in the method of FIGS. 4A and 4B;

FIG. 6 is a block diagram illustrating an example of a contents server included in the advertisement providing system of FIG. 2;

FIG. 7 is a block diagram illustrating an example of an advertisement server included in the advertisement providing system of FIG. 2;

FIG. 8 is a view of an example of an advertisement menu provided by the advertisement providing system of FIG. 2;

FIGS. 9A and 9B are diagrams illustrating a method of classifying advertisement files to construct first and second advertisement menus, according to embodiments of the present invention;

FIGS. 10A and 10B are views of web pages provided by the advertisement providing system of FIG. 2 to a user;

FIG. 11 is a block diagram illustrating an advertisement providing system according to another embodiment of the present invention; and

FIG. 12 is a block diagram illustrating a detailed structure of the advertisement providing system of FIG. 11.

### DETAILED DESCRIPTION OF THE INVENTION

In order to sufficiently understand the present invention, operational advantages of the present invention, and objectives achieved in embodiments of the present invention, the attached drawings illustrating embodiments of the present invention and descriptions presented therein need to be referred to.

Hereinafter, the present invention is to be described in detail by explaining embodiments of the present invention with reference to the attached drawings. In each of the drawings, like reference numerals denote like elements.

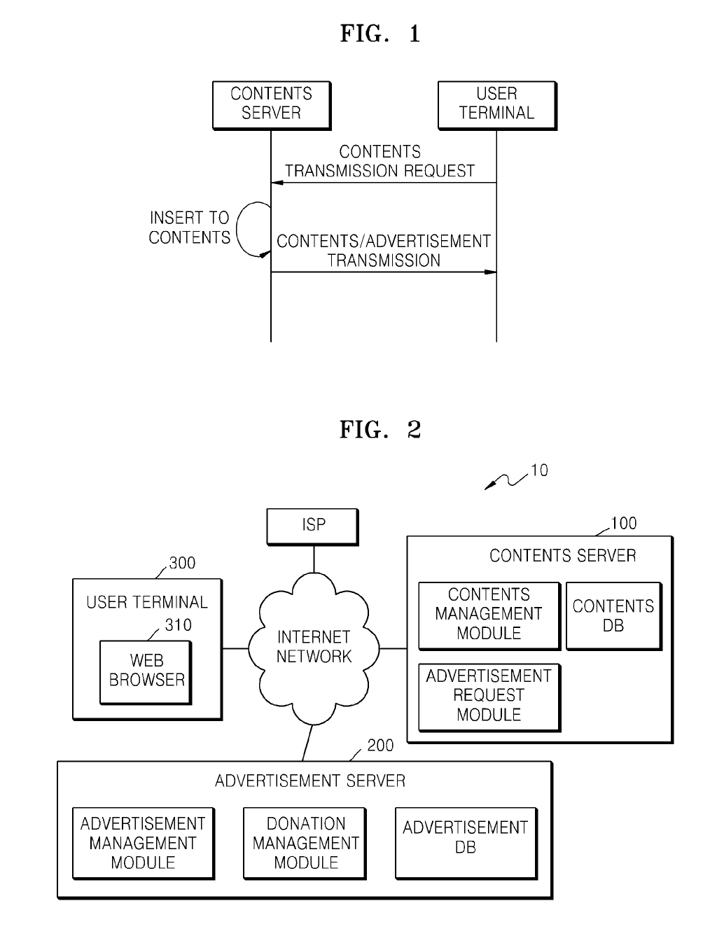

FIG. 2 is a diagram illustrating an advertisement providing system 10 according to an embodiment of the present invention. Referring to FIG. 2, the advertisement providing system 10 according to the present embodiment includes a contents server 100 and an advertisement server 200. Meanwhile, FIG. 2 also illustrates a user terminal 300 for receiving advertisement information from the advertisement providing system 10, together with various documents, images, and moving pictures, and an Internet service provider (ISP) for providing a communication service among the contents server 100, the advertisement server 200, and the user terminal 300, through an Internet network.

The user terminal 300 has access to the contents server 100 via a web browser 310 included in the user terminal 300, and selects various menus shown on a web page provided by the contents server 100 and receives corresponding contents. The contents server 100 includes a contents management module for managing contents to be provided to a user and a database for storing data-based contents. An operator managing the contents server 100 creates revenue by exposing various advertisements as a sort of revenue generation. In regard to the advertisement exposure, when the contents server 100 provides contents to a user, an advertisement file may also be transmitted together with the contents to the user. The user views the advertisement file first and then views or downloads the contents. The contents server 100 may store the advertisement file therein, and when a user requests downloading of the contents, the advertisement file may be transmitted to the user and then the contents are provided. FIG. 2 illustrates an embodiment in which the contents server 100 and the advertisement server 200 operate separately, and in this case, the contents server 100 may include the advertisement requirement module for requesting the advertisement server 200 to transmit an advertisement file to a user when the contents server 100 receives a contents transmission request from the user.

The advertisement server 200 transmits the advertisement file to the user in response to the advertisement request from the contents server 100. The contents server 100 provides an IP address of the user and information related to contents requested by the user to the advertisement server 200. In addition, when the contents server 100 and the advertisement server 200 are synchronized and provide a service, for example, when a user's account to log-in the contents server 100 or the advertisement server 200 is shared by the contents server 100 and the advertisement server 200, the contents server 100 may further provide information related to the corresponding user, for example, a user's account information to the advertisement server 200.

The advertisement server 200 includes an advertisement management module for transmitting advertisement files to a user or managing various advertisement files therein, and a database for storing various advertisement files. When the advertisement server 200 receives an advertisement request from the contents server 100, the advertisement server 200 transmits an advertisement file to a user by using various pieces of information transmitted together with the request, for example, an IP address of a user, information about contents requested by a user, or the user's account information.

For example, according to an embodiment of the present invention, instead of arbitrarily transmitting to a user an advertisement file that a user has no interest in, the advertisement server 200 transmits a menu screen containing information on various advertisement files to a user and transmits an advertisement file selected by the user. To do this, the advertisement server 200 constructs a menu screen by listing information transmitted by the contents server 100 and/or information about an advertisement file stored in the advertisement server 200 and other information. For example, a plurality of contents stored in the contents server 100 are classified according to a category (for example, society, economy, sports etc.), and information about the category to which contents requested by a user belong is transmitted to the advertisement server 200. The advertisement server 200 receives the category information, and constructs a menu screen to be transmitted to a user in such a way that a list of one or more advertisement files related to the selected category is provided. In addition, the advertisement server 200 classifies information about selected advertisements according to users and stores the classified information therein. When the user's account information is provided to the advertisement server 200, advertisement files that satisfy user's interests may be shown on the menu screen by referring to selected advertisement information of the corresponding user.

Meanwhile, when a plurality of advertisement files corresponding to any category information are included in the advertisement server 200, a menu screen may be constructed by taking into consideration information about advertisement selection frequencies of all users. As described above, since a list of advertisement files shown on the menu screen is constructed by taking into consideration an interest category of a user and advertisement selection frequencies of all users, advertisement files that a user has much interest in may be transmitted to the corresponding user. Thus, advertisement effects may be improved.

Meanwhile, the advertisement server 200 may transmit an advertisement file, in addition to before the transmission of contents, after the transmission of the contents is completed. The providing of the advertisement menu and the transmission of the selected advertisement file are performed prior to the transmission of contents, and the advertisement menu is to be referred to as a first advertisement menu and the selected advertisement file is to be referred to as a first advertisement file. When the transmission of contents is completed, the advertisement server 200 constructs a second advertisement menu and provides the second advertisement menu to the user and transmits to the user a second advertisement file selected by the user.

The second advertisement menu may be constructed using the information about the transmitted first advertisement menu. In regard to storing a plurality of advertisement files, the advertisement server 200 stores information about other advertisement files co-related to the respective advertisement files. Accordingly, the second advertisement menu may be constructed by listing a list of some of the other advertisement files related to the first advertisement menu. For example, the second advertisement menu may be constructed by listing a list of some of the other related advertisement files by taking into consideration the user's information (for example, information about a contents category or information about user's advertisement selection results). In addition, time-variant advertisement selection frequency of all users who have used corresponding contents may be further taken into consideration to construct the second advertisement menu. The second advertisement menu described above is provided to a user, and when the user performs a selection operation on the second advertisement menu, the advertisement server 200 transmits the selected second advertisement file to the user.

Meanwhile, in the case that a user views an advertisement file, in consideration of the economic value created by a corresponding advertisement viewing, a compensation (for example, money, product, service etc.) may be accumulated in a user's account whenever the user views the advertisement file. In addition, the accumulated compensation may be provided to the user as a gain, or donated to other institutions or organizations. In an embodiment of the present invention, such accumulation and donation-related operations are provided. To do this, the advertisement server 200 includes a donation management module. In addition, the advertisement menu may further include a menu for inputting a user's account and a menu for selecting a subject that will receive the donated compensation so as to donate the accumulated compensation to other institutions or organizations, on a portion of a menu screen. The related structure will be described in detail later.

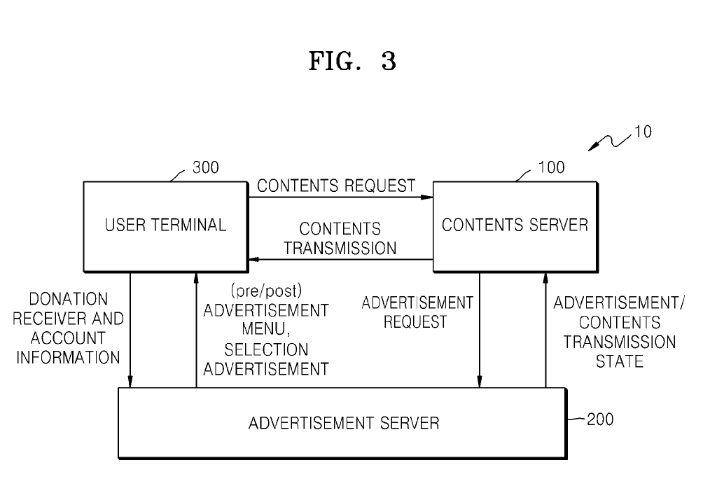

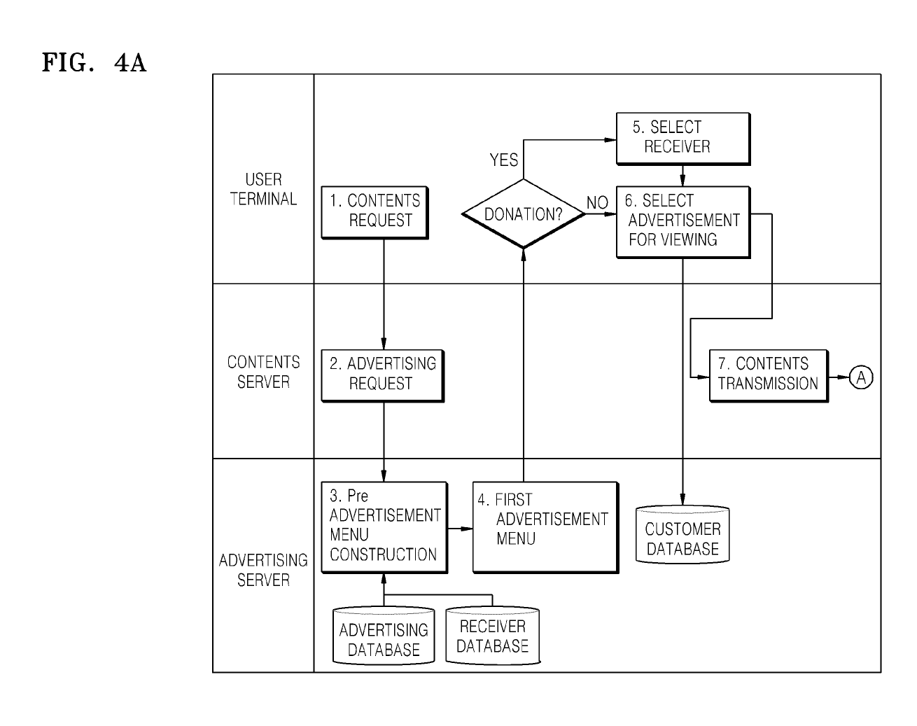

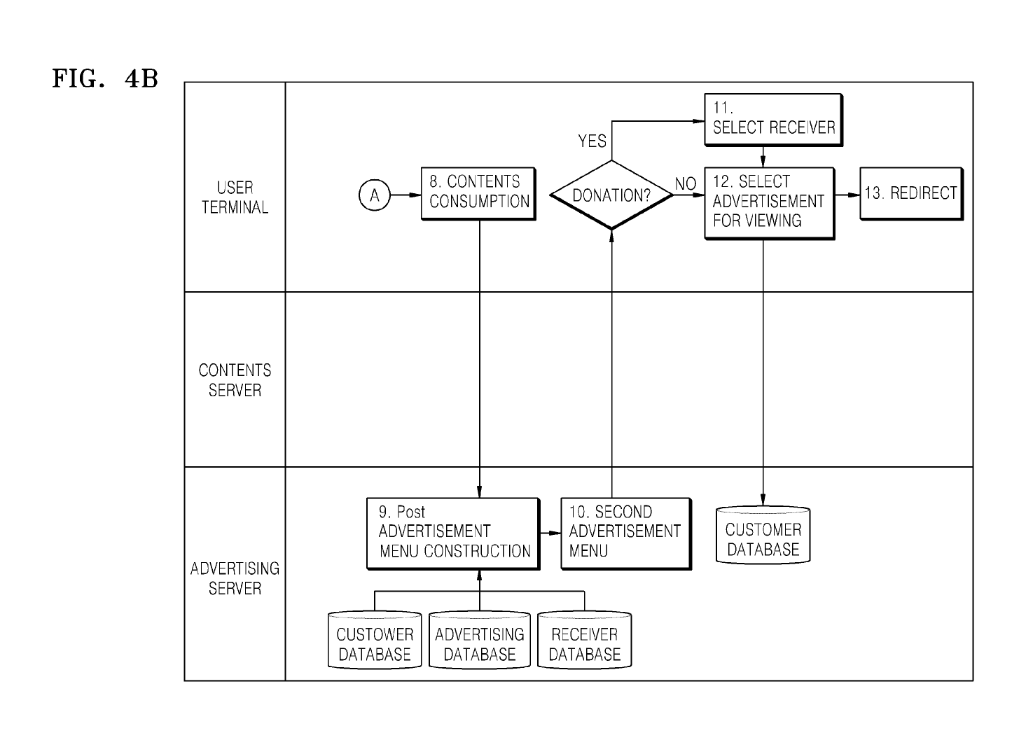

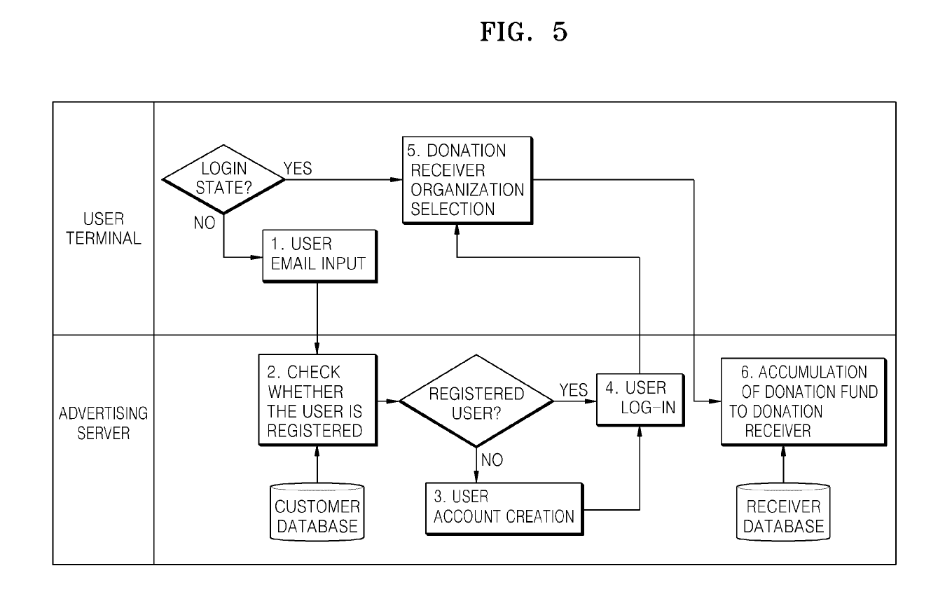

FIG. 3 is a block diagram illustrating a method for providing the advertisement providing system 10 of FIG. 2, and FIGS. 4A and 4B are views to sequentially explain operations for performing the method of providing the advertisement providing system 10 of FIG. 2. A method of providing an advertisement providing system according to an embodiment of the present invention is to be described in detail with reference to FIGS. 3, 4A and 4B.

The advertisement providing system 10 performs an advertisement providing process by receiving and/or transmitting various pieces of information, contents, and advertisements among the contents server 100, the advertisement server 200, and the user terminal 300. When the user terminal 300 has access to the contents server 100 and desired contents are selected, the contents server 100 requests the advertisement server 200 to transmit an advertisement to a user. The advertisement server 200 constructs a first advertisement menu (Pre advertisement menu) by listing, in addition to the advertisement request, other information transmitted by the contents server 100. When the first advertisement menu is constructed, an advertisement database and a database for storing information about a donation receiver organization (hereinafter, referred to as a receiver) are referred to. For example, the advertisement database includes a plurality of advertisement files and classification information about the respective advertisement files. The first advertisement menu is constructed by selecting advertisement files stored in the advertisement database with reference to category information transmitted by the contents server 100 or selection frequency information of advertisement files stored in the advertisement server 200. In addition, in order to donate the accumulated compensation (for example, a reserve fund) created by the advertisement viewing, information about various organizations to which the accumulated compensation is to be donated is obtained from a receiver database, and the information is shown on one side of the first advertisement menu. The first advertisement menu constructed as described above is provided to the user terminal 300.

The user determines donation of the compensation, or selects a donation receiver. When the user does not determine the donation of the compensation and does not select a donation receiver, an advertisement file selected by the user is transmitted immediately and the user views the advertisement file. On the other hand, when the user determines the donation of the compensation and selects a donation receiver, the related information is transmitted to the advertisement server 200 and the advertisement server 200 stores the corresponding information in a database therein. In addition, when a user logs in the advertisement server 200 by, for example, inputting account information, information about the advertisement file selected by the user is stored in a user information database (in the embodiments illustrated in FIGS. 4A, 4B and 5, the user is assumed to be a customer who uses the contents server and the user information database is indicated as a customer database) of the advertisement server 200, and the stored information is used to construct the first and second advertisement menus later.

When transmission of the first advertisement file is completed, the advertisement server 200 provides information about the complete transmission to the contents server 100. In response to the information, the contents server 100 transmits contents to the user terminal 300. When the user fully views the contents, the contents server 100 provides information about the complete viewing to the advertisement server 200. In response to the information, the advertisement server 200 constructs the second advertisement menu and transmits the second advertisement menu to the user terminal 300. Meanwhile, in regard to the donation of the accumulated compensation, when a user's account is input in advance when the first advertisement file is provided, only a menu for selecting a donation receiver that will receive a reserve fund created by viewing the corresponding second advertisement file is activated in the second advertisement menu.

The advertisement server 200 constructs the second advertisement menu by listing various pieces of information stored in a database. For example, category information about contents selected by a user or advertisement files selected by the user may be stored in the user information database, and also, selection frequency information of advertisement files of all users may be stored in the user information database. The second advertisement menu may be constructed by displaying a list of a plurality of other advertisement files related to the first advertisement file with reference to information of the first advertisement file selected by the user. In addition, some of the related advertisement files may be selected by referring to various pieces of information stored in a database among a plurality of other advertisement files, and the selected related advertisement files are used to construct the second advertisement menu.

Meanwhile, the second advertisement menu may further include a menu for inputting the user's account information or a menu for selecting a distribution receiver organization. If the second advertisement menu is provided to the user terminal 300, according to whether the accumulated compensation (hereinafter, assuming that the compensation is a fund, the accumulated compensation is indicated as a reserve fund) is donated, the user's account information or the donation receiver information is provided to the advertisement server 200. In addition, when the user selects an advertisement file via the second advertisement menu, the advertisement server 200 transmits the corresponding second advertisement file to the user terminal 300. The user views the second advertisement file, and information about the advertisement file selected by the user is stored in the user information database of the advertisement server 200. Meanwhile, as illustrated in FIGS. 4A and 4B, when the second advertisement file is transmitted to the user terminal 300, the advertisement server 200 may further transmit other information related to the first and/or second advertisement file, for example, address information for redirecting the corresponding web site related to the selected advertisement to the user terminal 300, and the user may be redirected to the corresponding web page by performing a selection operation.

FIG. 5 is a view to sequentially explain functions related to a method of selecting a donation receiver in the method of FIGS. 4A and 4B. An operation using the first advertisement menu and an operation using the second advertisement menu are equivalent or similar to each other. Thus, only an operation using the first advertisement menu is to be described as an example.

Referring to FIG. 5, when a user inputs account information, the advertisement server 200 executes a log-in process. First, when the user wants to donate a reserve fund created by advertisement viewing, the user inputs his or her account information in an account information input menu shown in a portion of the first advertisement menu. The account information may not be limited, and for example, a user's email account may be used as the account information. The advertisement server 200 confirms whether the input account information is already input by using information stored in the customer database, and when the user is not a registered user, a user account is generated. On the other hand, if the user is a registered user, the log-in operation is finished.

When the log-in operation is finished, the user performs a selection operation on a list of donation receiver organization shown in another portion of the first advertisement menu. When a donation receiver organization is selected, the advertisement server 200 accumulates a reserve fund created by the advertisement viewing in the corresponding organization. The accumulation details for organizations may be stored in a database for storing information related to donation organizations (for example, a receiver database.)

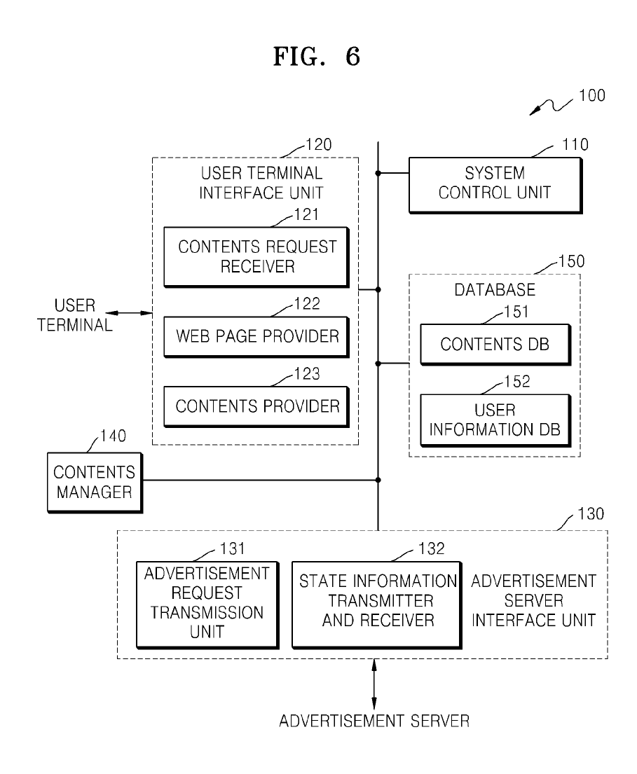

FIG. 6 is a block diagram illustrating an example of the contents server 100 included in the advertisement providing system 10 of FIG. 2. Referring to FIG. 6, the contents server 100 includes a system control unit 110 for controlling the overall system, a user terminal interface unit 120 for receiving a contents request from the user terminal 300 and providing contents correspondingly, an advertisement server interface unit 130 for requesting the corresponding advertisement to the advertisement server 200 when a contents supply request is received, a contents manager 140 for storing/extracting contents and managing various pieces of information related to the contents, and a database 150 for storing contents and various pieces of information.

The user terminal interface unit 120 may include a contents request receiver 121 for receiving a contents request from the user terminal 300, a web page provider 122 for providing a web page including a contents selection menu to the user terminal 300, and a contents provider 123 for providing contents according to a user's selection. The advertisement server interface unit 130 may include an advertisement request transmission unit 131 for requesting transmission of an advertisement to a user when the user's contents request is received, and a state information transmitter and receiver 132 for transmitting information about a transmission state of contents or receiving information about a transmission state of an advertisement file. The database 150 may include a database 151 for storing contents and a database 152 for the user's account information.

A user has access to the contents server 100, checks a list of contents shown on a web page provided by the contents server 100, and selects contents the user wants to view. When the contents server 100 receives the contents request, the advertisement request transmission unit 131 provides an advertisement transmission request to the advertisement server 200. Then, when transmission of an advertisement file to a user by the advertisement server 200 is completed, information about the complete transmission of the advertisement file is transmitted to the state information transmitter and receiver 132. Under the management of the contents manager 140, contents requested by a user are extracted from the database 150 and the extracted contents are transmitted to the user terminal 300 via the contents provider 123. Contents stored in the database 150 may be classified according to a category, and in this case, category information of the corresponding contents may also be stored in the database 150. In addition, the user information database 152 stores information about users registered to the contents server 100. In regard to construction of an advertisement menu by the advertisement server 200, the category information stored in the database 150 may be provided to the advertisement server 200. In addition, when the contents server 100 and the advertisement server 200 share the user's account information, information about a user requesting contents may be provided to the advertisement server 200. Accordingly, even when a user does not log in the advertisement server 200, various pieces of information about the user, for example, basic information and advertisement selection details of the user may be used to construct the first and/or second advertisement menus.

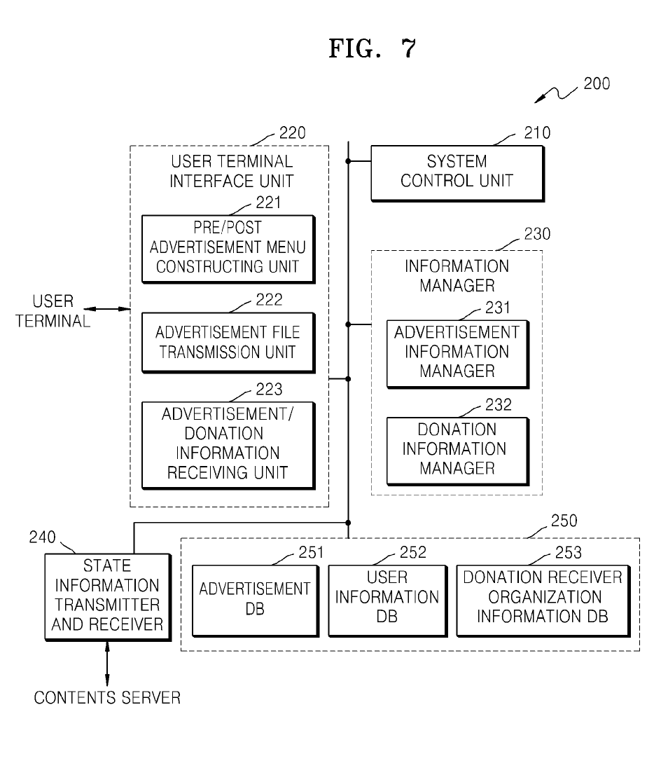

FIG. 7 is a block diagram illustrating an example of the advertisement server 200 included in the advertisement providing system 10 of FIG. 2. Referring to FIG. 7, the advertisement server 200 includes a system control unit 210 for controlling the overall system, a user terminal interface unit 220, an information manager 230, a state information transmitter and receiver 240, and a database 250. The user terminal interface unit 220 may include a pre/post advertisement menu constructing unit 221, an advertisement file transmission unit 222, and an advertisement/donation information receiving unit 223, and the information manager 230 may include an advertisement information manager 231 and a donation information manager 232. The database 250 may include a database 251 for storing advertisement files, a database 252 for storing various pieces of user information, for example, the user's account information, and information about advertisement selection details and accumulated revenue details, and a database 253 for storing information about a donation receiver organization in order to donate the accumulated revenue to other organizations.

When an advertisement transmission request is received from the contents server 100 via the state information transmitter and receiver 240, the pre/post advertisement menu constructing unit 221 constructs a first advertisement menu and transmits the first advertisement menu to the user terminal 300. As described above, the first advertisement menu may be constructed by considering contents category information, advertisement file selection frequency information, and user information, and the advertisement information manager 231 provides the information to the pre/post advertisement menu constructing unit 221 in order to construct the first advertisement menu. Information about advertisement files corresponding to the contents category information or advertisement file selection frequency information may be stored in the advertisement database 251. In addition, user information related to construction of the first advertisement menu may be stored in the database 252 for storing user information. The first advertisement menu may further include a menu for requesting input of user account information and a menu for selecting a donation receiver which will receive the accumulated revenue, and to do this, information stored in the database 253 for storing donation organizations information may be referred to.

When the advertisement/donation information receiving unit 223 receives advertisement selection information, the advertisement file transmission unit 222 transmits the corresponding advertisement file to the user. When the transmission of the selected advertisement file is completed, the state information transmitter and receiver 240 provides information about the complete transmission to the contents server 100, and the contents server 100 transmits to the user contents requested by the user. When the transmission of the contents is completed, the pre/post advertisement menu constructing unit 221 constructs the second advertisement menu and transmits the second advertisement menu to the user. The second advertisement menu may be constructed by referring to, as described above, information about the first advertisement file selected by the user, information about a user's advertisement selection details, advertisement file selection frequency information, etc. When a donation receiver organization is selected via the first advertisement menu, the information about the selected donation receiver organization may be further used in constructing the second advertisement menu. For example, the second advertisement menu may include an advertisement for promoting various businesses related to the corresponding organization or an advertisement for other organizations related to the corresponding organization.

The donation information manager 232 may manage operations related to the accumulation and donation in case a user inputs account information and requests donation of the accumulated revenue. For example, the donation information manager 232 operates independently from the construction of the first and second advertisement menu or the transmission of advertisement files. In an embodiment, the donation information manager 232 manages accumulation details of users created by advertisement viewing, and an operation for donating the reserve fund to another organization according to a user's selection. In FIG. 7, the advertisement information manager 231 and the donation information manager 232 are each illustrated as independent structures. However, in an actual system, both the management operation related to the advertising and the management operation related to the donation may be processed by one element.

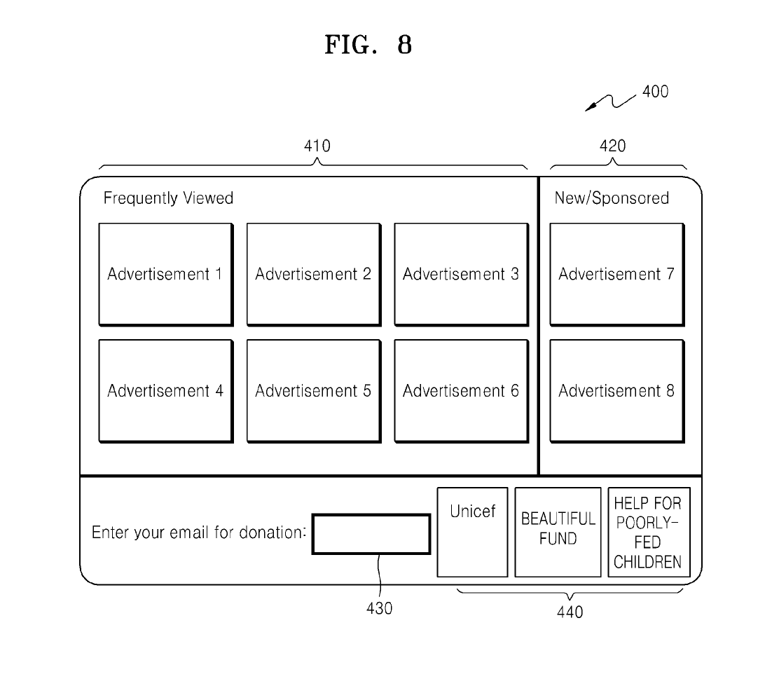

FIG. 8 is a view of an example of an advertisement menu provided by the advertisement providing system 10 of FIG. 2. A menu screen illustrated in FIG. 8 may be the first advertisement menu or the second advertisement menu. For example, the menu screen illustrated in FIG. 8 is the first advertisement menu, and the first advertisement menu may be constructed by referring to contents category information and advertisement file selection frequency information. Referring to FIG. 8, advertisement files 1 through 8 are part of a plurality of advertisement files belonging to the category information. The advertisement files 1 through 6 are selected from advertisement files having high selection frequencies among the advertisement files belonging to the category information, and in order to retain exposure frequency equity with respect to newly registered advertisement files, some of the newly registered advertisement files are also included in the first advertisement menu. For example, the advertisement file 7 and advertisement file 8 are included in the first advertisement menu. In addition, in regard to the donation operation, a menu for inputting user's account information (for example, an e-mail account) and a menu for showing a list of organizations to which a reserve fund is to be donated are included in the first advertisement menu.

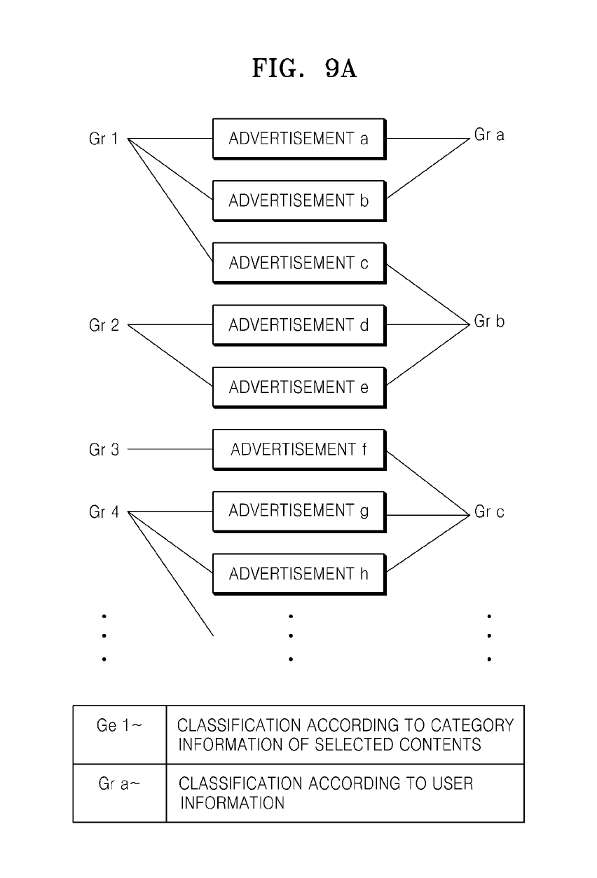

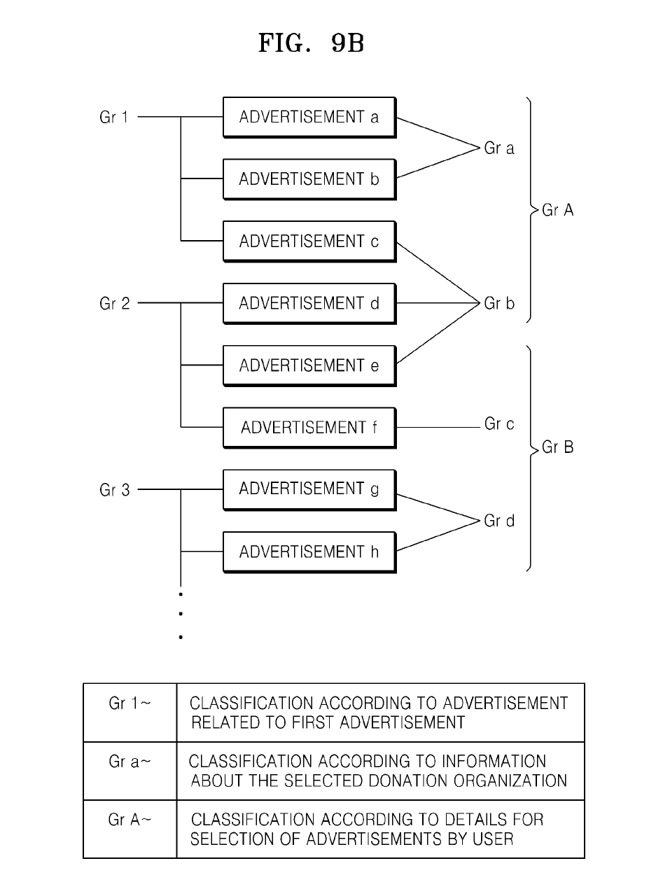

FIGS. 9A and 9B are diagrams illustrating a method of classifying advertisement files to construct first and second advertisement menus, according to embodiments of the present invention. FIG. 9A illustrates an example of a method of classifying advertisement files to construct the first advertisement menu, and a plurality of advertisements (advertisements a through h) are classified according to one or more standards. For example, a plurality of advertisements may be classified into a plurality of groups Gr1, Gr2, . . . according to contents category information, and alternatively, a plurality of advertisements may also be classified into a plurality of groups Gra, Grb, . . . according to user information. When the first advertisement menu is constructed using the category information, a list of advertisement files having high selection frequencies among advertisement files belonging to any category information is used to construct the first advertisement menu. Alternatively, the first advertisement menu is constructed using the category information and the user information, a list of advertisement files having high selection frequencies among advertisement files commonly belonging to the corresponding category information and user information is used to construct the first advertisement menu.

Meanwhile, FIG. 9B illustrates an example of a method of classifying advertisement files to construct the second advertisement menu, and as illustrated in FIG. 9B, a plurality of advertisements (advertisements a through h) may be classified into a plurality of groups Gr1, Gr2, . . . , wherein each of the groups consists of advertisements related to each other. Alternatively, the advertisements (advertisements a through h) may be also classified into a plurality of groups Gra, Grb, . . . according to donation receiver organization. Alternatively, the advertisements (advertisements a through h) may be also classified into a plurality of groups GrA, GrB, . . . according to a user's advertisement selection details. In regard to the construction of the second advertisement menu, a plurality of advertisement files are selected by referring to the classifications, and a list of advertisement files is further selected from the selected advertisement files by referring to a selection frequency.

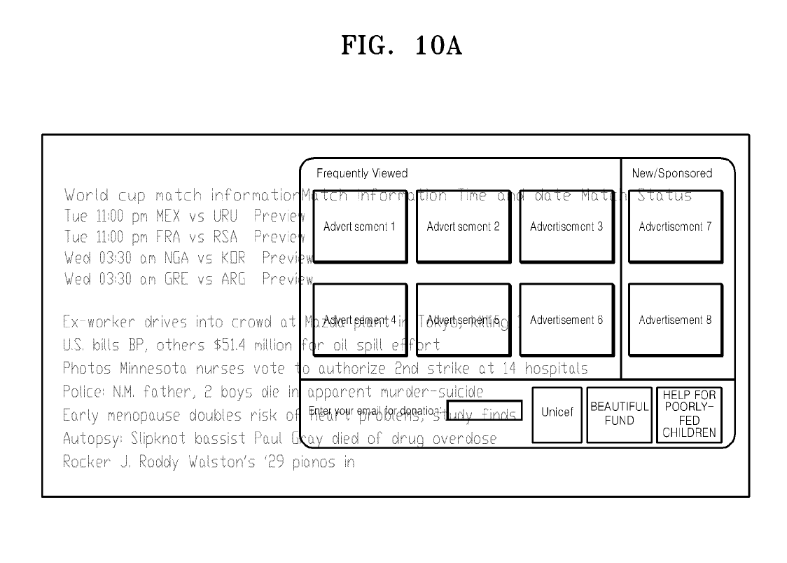

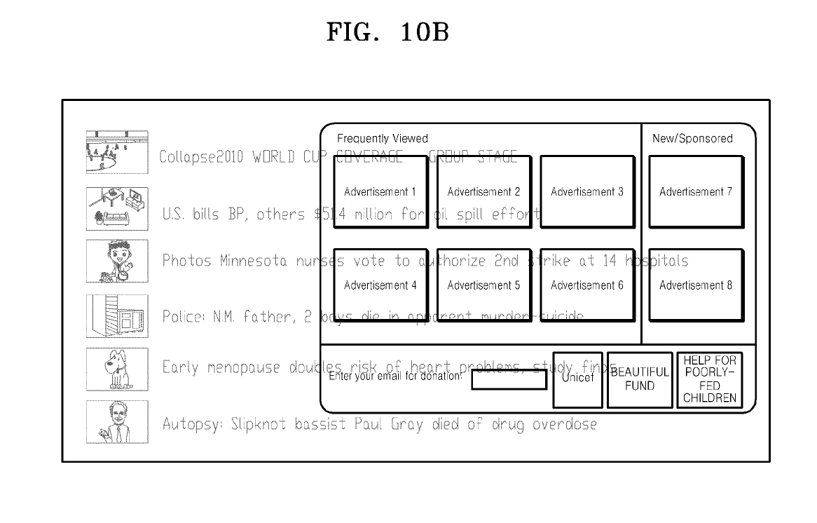

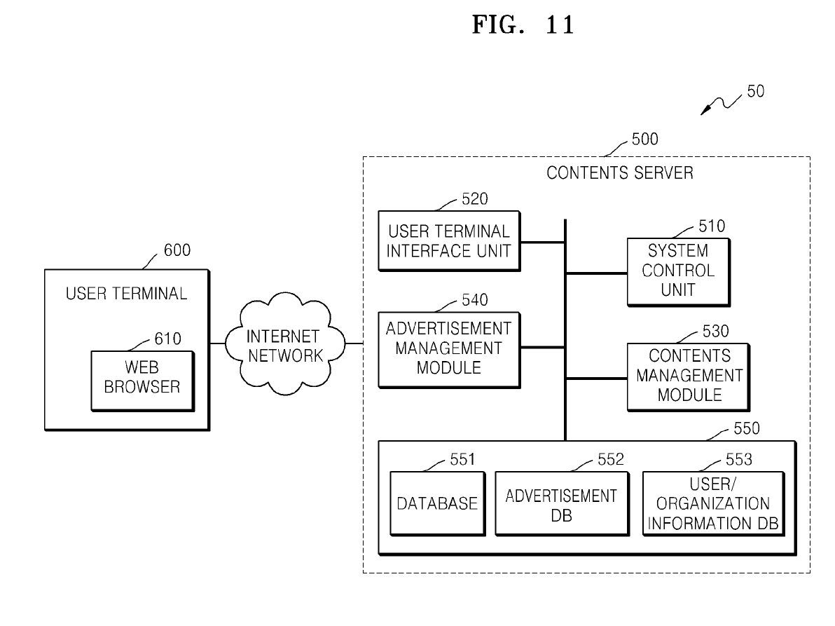

FIGS. 10A and 10B are views of web pages provided by the advertisement providing system 10 of FIG. 2 to a user. In an embodiment illustrated in FIG. 10A, in a web page for providing text contents, when a user selects desired text contents, an advertisement menu is activated and provided to the user before the contents are transmitted to the user. The user selects an advertisement file he or she wants to view and views the corresponding advertisement, and when the advertisement viewing is completed, a contents screen is activated. Likewise, referring to FIG. 10B, in a web page for providing media contents, such as a moving picture or an image, when a user selects desired medium contents, an advertisement menu is activated and provided to the user before downloading. When the viewing of the selected advertisement is completed, a window for downloading contents is activated and the user consumes the corresponding contents.

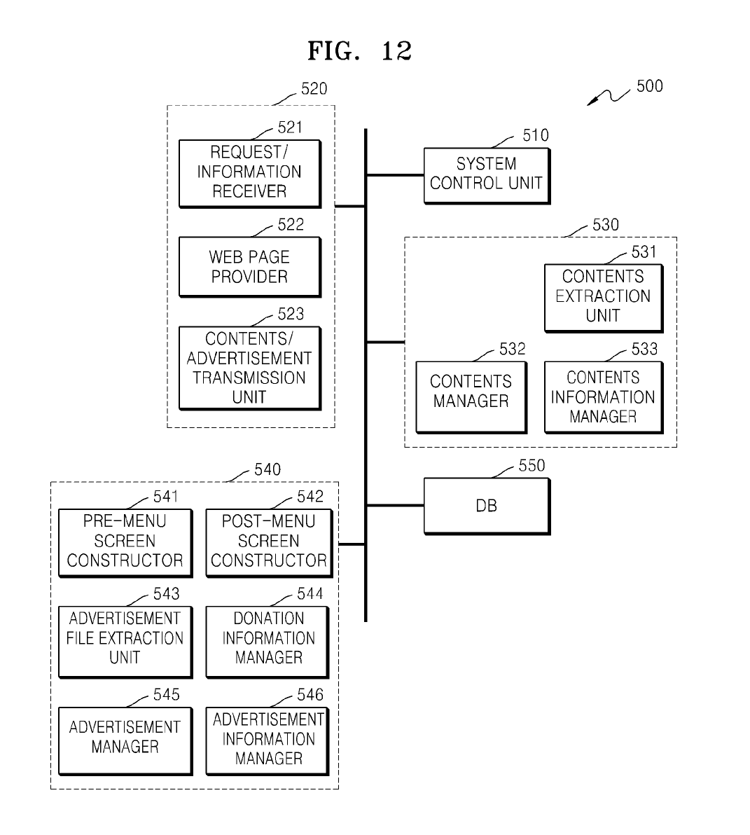

FIG. 11 is a block diagram illustrating an advertisement providing system 50 according to another embodiment of the present invention. The advertisement providing system 50 of FIG. 11 may operate in the same way as or similar way to the advertisement providing system 10 previously described above. Referring to FIG. 11, a contents server 500 may further include an element for functioning as an advertisement server, and accordingly, the contents server 500 transmits both contents and advertisement files to a user. In this regard, the advertisement providing service is provided in such a way that business people who want to expose their advertisements directly make an advertisement exposure contract with an operator who operates the contents server 500, and the contents server 500 directly stores the corresponding advertisement file and transmits the corresponding advertisement file to the user.

Referring to FIG. 11, the contents server 500 transmits contents and advertisement files to a user terminal 600 via an Internet network. The user terminal 600 includes a web browser 610, and a contents request is provided to the contents server 500 via the web browser 610. When the contents server 500 transmits an advertisement file to the user terminal 600 and the viewing of the corresponding advertisement file is completed, the contents server 500 transmits the requested contents to the user terminal 600. To do so, the contents server 500 may include a system control unit 510 for controlling an overall system, a user terminal interface unit 520, a contents management module 530, an advertisement management module 540, and a database 550. The database 550 may include a database 551 for storing contents, a database 552 for storing advertisement files, and a database 553 for storing user information and information about organizations which will receive revenues accumulated according to advertisement viewing. The contents management module 530 performs the same or similar process as in the contents server 100 of FIG. 6. In addition, the advertisement management module 540 performs the same or similar process as in the advertisement server 200 of FIG. 7.

FIG. 12 is a block diagram illustrating a detailed structure of the advertisement providing system 50 of FIG. 11. Referring to FIG. 12, the user terminal interface unit 520 may include a request/information receiver 521, a web page provider 522, and a contents/advertisement transmission unit 523, and the contents management module 530 may include a contents extraction unit 531, a contents manager 532, and a contents information manager 533. In addition, the advertisement management module 540 may include a Pre-menu screen constructor 541, a Post-menu screen constructor 542, an advertisement file extraction unit 543, a donation information manager 544, an advertisement manager 545, and an advertisement information manager 546.

The request/information receiver 521 receives a contents transmission request provided by the user terminal 600, advertisement menu selection information, and various pieces of user information. The web page provider 522 provides a web page to a user who has access to the contents server 500, so that the user consumes contents and views advertisements on the web page. The contents/advertisement transmission unit 523 transmits to the user contents and an advertisement file, which are selected by the user.

The contents extraction unit 531 extracts contents requested by the user from the database 550 and transmits the extracted contents to the contents/advertisement transmission unit 523. The contents manager 532 performs various management processes related to contents, for example, storing, changing, and deleting of contents. The contents information manager 533 performs various management processes such as storing, changing, and deleting of various pieces of information related to the contents. For example, the contents may be classified into various categories such as society, economy, sports, etc, and the contents information manager 533 may perform a management process with respect to the category information.

Meanwhile, the Pre-advertisement menu constructing unit 541 constructs a first advertisement menu before contents are transmitted to the user, and the Post-menu screen constructor 542 constructs a second advertisement menu after the contents are transmitted to the user. As described above, the Pre-advertisement menu constructing unit 541 and the Post-menu screen constructor 542 construct the first and second advertisement menus by referring to various pieces of information. The advertisement file extraction unit 543 extracts an advertisement file selected by the user from the database 550, and the donation information manager 544 manages either accumulated details created by the user's advertisement viewing or an operation for donation of a reserve fund by the user. The advertisement manager 545 manages storing, changing, and deleting operations of advertisement files, the advertisement information manager 546 manages information about classification according to various standards with respect to advertisement files, and the first and second advertisement menus are constructed by listing the classification information.

According to the systems and methods for providing a personalized advertisement service according to the above embodiments of the present invention, the user's attention is effectively attracted by providing a personalized advertisement service. Thus, rational advertisement effects caused by advertisement exposure may occur. In addition, a revenue corresponding to the economic value created by advertisement viewing may be rationally distributed.

While the present invention has been particularly shown and described with reference to exemplary embodiments thereof, it is to be understood by those of ordinary skill in the art that various changes in form and details may be made therein without departing from the spirit and scope of the present invention as defined by the following claims.

What is claimed is:

1. An advertisement providing system comprising:
a contents server for storing a plurality of contents to provide contents in response to a user's request, generating a request of an advertisement transmission to the user and information about the requested contents, when a contents request made by the user is received, and transmitting the contents to the user when the advertisement transmission to the user is completed; and
an advertisement server for storing a plurality of advertisement files, constructing a first advertisement menu comprising a list of advertisements corresponding to the contents information in response to an advertisement transmission request by the contents server, providing a first advertisement file selected by the user via the first advertisement menu to the user, constructing a second advertisement menu including a list of advertisements corresponding to the first advertisement file selected via the first advertisement menu when the contents transmission to the user by the contents server is completed and providing a second advertisement file selected by the user via the second advertisement menu to the user.

2. The advertisement providing system of claim 1, wherein the contents server classifies a plurality of contents according to a plurality of categories, and provides content category information as information related to the contents to the advertisement server, and
the advertisement server classifies a plurality of advertisement files according to information about the categories, and constructs the first advertisement menu by listing at least one advertisement files corresponding to the category information provided by the contents server.

3. The advertisement providing system of claim 2, wherein the advertisement server stores information about one or more advertisement files related to each of the advertisement files, and constructs the second advertisement menu by listing at least one advertisement file selected from the related advertisement files corresponding to the first advertisement file selected via the first advertisement menu.

4. The advertisement providing system of claim 3, wherein at least one of the first and second advertisement menus is constructed by listing at least one advertisement file selected from a plurality of advertisement files and time-variant selection frequency information with respect to the advertisement files.

5. The advertisement providing system of claim 3, wherein the advertisement server operates a log-in process by requesting input of user's account information to accumulate revenue of the user created by corresponding advertisement viewing, when the first advertisement menu is transmitted to the user.

6. The advertisement providing system of claim 5, wherein the advertisement server, when the user's account information is input, stores advertisement viewing details of a user corresponding to the user's account information, and constructs the second advertisement menu by further using advertisement viewing information of the user.

7. The advertisement providing system of claim 5, wherein the advertisement server, in response to a request of the log-in user, transfers revenue accumulated to the account of the user to a donation organization.

8. The advertisement providing system of claim 1, wherein the advertisement server, when the user performs a selection operation on the second advertisement menu, further transfers link information to the user so that the user is redirected to a web page related to the first or second advertisement file after the second advertisement file is transmitted.

9. A computer readable storage medium on which a program code for operating the advertisement server of claim 1.

10. An advertisement server that comprises a plurality of advertisement files, and is synchronized with a contents server and provides an advertisement file to a user, the advertisement server comprising:
an advertisement menu constructing unit for constructing first and second advertisement menus that are to be transmitted to the user in response to an advertisement transmission request transmitted by the contents server;
an advertisement file transmission unit for transmitting first and/or second advertisement file in response to a selection of the user with respect to the first and/or second advertisement file;
a state information transmitter and receiver for transmitting information about complete transmission of the first advertisement file to the contents server when transmission of the first advertisement file is completed, and receiving information about complete transmission of contents when transmission of the contents to the user is completed ; and
a database unit for data-basing a plurality of advertisement files, account information about a user who logs in the advertisement server, and user's advertisement files selection details and storing the data-based results
wherein the advertisement menu constructing unit constructs the first advertisement menu in response to the advertisement transmission request transmitted by the contents server, and constructs the second advertisement menu in response to information about complete transmission of the contents.

11. The advertisement server of claim 10, wherein the advertisement menu constructing unit constructs the first advertisement menu by listing a list of at least one advertisement file selected from the advertisement files in consideration of information about a category of contents selected by the user, and constructs the second advertisement menu by listing at least one advertisement file related to the first advertisement file by using information about the first advertisement file selected by the user by referring to the first advertisement menu.

12. The advertisement server of claim 10, wherein the advertisement menu constructing unit further provides a menu for inputting account information of the user and a menu for selecting a donation organization to which a revenue created by viewing the first and second advertisement files is to be donated, in order to accumulate the revenue to the user.

13. The advertisement server of claim 12, further including an information manager for managing storing of advertisement file selection information of the user, and storing of details for advertisement file viewing of the user, details for accumulated revenue created by viewing the advertisement file, and information about a donation organization to which the accumulated revenue is to be donated.

14. A method of providing an advertisement providing system for storing a plurality of advertisement files,
receiving, from a contents server for receiving a contents transmission request from a user, an advertisement transmission request and category information about a category of contents selected by a user;
constructing a first advertisement menu comprising a list of at least one advertisement file corresponding to the contents category information;
providing a first advertisement file selected by the user via the first advertisement menu to the user;
constructing a second advertisement menu comprising a list of at least one advertisement file related to the first advertisement file, when the transmission of the first advertisement file and transmission of contents to the user from the contents server are completed; and
providing a second advertisement file selected by the user via the second advertisement menu to the user.

15. The method of claim 14, wherein
the advertisement files are classified into a plurality of groups in response to the contents category information, and
in the constructing of the first advertisement menu, a menu for some advertisement files selected from a plurality of advertisement files which belong to the category information of the selected contents, by referring to a selection frequency of the respective advertisement files, is constructed.

16. The method of claim 15, wherein
information about a plurality of other advertisement files related to the respective advertisement files is stored, and
in the constructing of the second advertisement menu, a menu for some advertisement files selected from a plurality of advertisement files related to the first advertisement file selected via the first advertisement menu, by referring to a selection frequency of the respective advertisement files, is constructed.

17. The method of claim 14, wherein at least one operation of the constructing of the first advertisement menu and the constructing of the second advertisement menu,
constructing, in addition to the first or second advertisement menus, a menu for inputting a user's account and a menu for selecting a donation organization to which a revenue created by viewing the first or second advertisement files is to be donated, in order to accumulate the revenue to the user.

18. The method of claim 17, further comprising:
inputting the user's account;
according to selection of the user, receiving a request for donating the accumulated revenue to the organization; and
in response to the request, donating the revenue accumulated by the user to the organization.
